(19) United States
(12) Patent Application Publication
(10) Pub. No.: US 2014/0304795 A1
(43) Pub. Date: Oct. 9, 2014

(54) MODULAR AUTHENTICATION DEVICE COMBINING BIOMETRIC AND RFID SENSORS

(71) Applicants: Philip J. Bruno, Oakland, CA (US); Robert A.D. Schwartz, Oakland, CA (US); Paul Schwartz, Oakland, CA (US)

(72) Inventors: Philip J. Bruno, Oakland, CA (US); Robert A.D. Schwartz, Oakland, CA (US); Paul Schwartz, Oakland, CA (US)

(21) Appl. No.: 14/243,715

(22) Filed: Apr. 2, 2014

Related U.S. Application Data
(60) Provisional application No. 61/809,185, filed on Apr. 5, 2013.

(51) Int. Cl. G06F 21/34; G06F 21/32

(52) U.S. Cl. CPC G06F 21/34; G06F 21/32
USPC 726/9

(57) ABSTRACT

A modular identity authentication apparatus for a computer system includes at least two different authentication technologies, such as biometric fingerprint readers, NFC-RFID receivers, and BYOD sensors. Each modular apparatus provides multiple authentication sensors that are connected through a single port at a computer terminal location. System software permits terminal use when all module devices are authenticated, and shuts down the terminal whenever the module is disconnected.

### CROSS-REFERENCE TO RELATED APPLICATIONS

This application claims the benefit of the filing date priority of Provisional Appl. no. 61/809.185, filed Apr. 5, 2013.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to a modular authentication device for use with a computer system, particularly a computer system that requires secure log-in identification of at least two differing types.

2. Description of Related Art

As computer systems have become more and more essential to the operation of businesses and institutions, there has been a concomitant increase in the number of terminals, work stations, desktop computers and the like that are connected to the computer system that serves the business or institution. One of the many uses of a central computer system is the storage of records that should be held confidential, such as medical data regarding individuals, personnel records, financial records and transactions of the business or institution, payroll records, and the like. For this and other reasons there is a definite need for some form of security system to limit access to confidential information, not to mention access to computerized functions such as payroll, billing, and the like. On the other hand, it is necessary to grant access of some sort to a large number of individuals so that they may carry out their assigned tasks which often involve interaction with the computer system. The confluence of the requirement for confidentiality and the need to grant access has lead to a proliferation of security measures and systems that are designed to recognize individuals who are authorized to have access to the computer system and at least some portion of its records and functions, while denying access to those individuals who endeavor to gain access to the system without authorization.

The most common security devices and measures currently in use include passwords assigned individually to each employee, biometric sensors such as fingerprint readers, iris scanners, facial recognition, and the like, and electronic scanners such as RFID or NFC-RFID for security cards or badges. Recently upgraded standards suggest or require the combined use of the two different types of sensors: at least one biometric sensor together with at least one electronic sensor, in addition to, or substitution for, the use of an individual password. Multiple sensors may be designed into newly produced equipment without undue difficulty, but it is more problematic to update and upgrade existing computer systems, particularly those having a large number of terminals. One approach to this task is depicted in U.S. patent application Ser. No. ______, filed ______, that describes a modular, modifiable keyboard construction that may incorporate a combination of the required user authentication devices.

However, in many instances it may be necessary to upgrade an existing system in which the modular modifiable keyboard cannot be used effectively. Connecting multiple authentication devices to an existing system requires sufficient ports (USB or equivalent), and arrangements to provide those ports may not be cost-effective. Likewise, separate devices may be easier to hack, since there is no security synergism between the individual authentication devices.

### BRIEF SUMMARY OF THE INVENTION

The present invention generally comprises a modular identity authentication device for use with a terminal or workstation or desktop computer setup. A salient feature of the module is that it is designed to accommodate a variety of security features that may be installed in the module during manufacturing, whereby various combinations of devices that impart selected security features may be assembled. The resulting module integrates a plurality of security devices into one enclosed structure, reducing the proliferation of desktop devices surrounding the keyboard and monitor, and simplifying the wiring of the system. The module provides dual ID authentication modalities in one compact unit that may be connected to an existing (or new) computer system through a single port, such as a USB connection.

In one aspect the invention provides a device having a unique modular system designed to house to accommodate at least two discreet verification technologies: a biometric sensor and an EM sensor. The biometric sensor may comprise a fingerprint reader device, and the EM sensor may comprise an RFID contactless card reader, and/or an NFC device scanner. Alternatively or in addition, the module may incorporate a Bluetooth™ module for detecting the presence of a BYOD (bring your own device) electronic device (mobile phone or the like) that is expected to accompany an authorized individual who also presents the proper fingerprint and RFID card(s) for authentication.

The module, once fitted with the selected input technology is connected electronically via a USB port at a terminal location. Software in the host computer system interrogates the module and allows access to the terminal only when the authentication devices in the module transmit data that is recognized and approved by the system software. Likewise, the terminal is dropped from the system whenever the module is disconnected from the terminal location.

### BRIEF DESCRIPTION OF THE DRAWING

FIG. 1 is a plan view depicting the modular ID authentication device of the invention.

FIG. 2 is an end view of the modular ID authentication device shown in FIG. 1.

FIG. 3 is a plan view depicting an alternative embodiment of the modular ID authentication device of the invention.

FIG. 4 is an end view of the modular ID authentication device shown in FIG. 3.

FIG. 5 is a functional flow chart depicting the steps in the method of the system software that runs the modular ID authentication device.

FIG. 6 is a block diagram of the components in the modular ID authentication device of the invention.

### DETAILED DESCRIPTION OF THE INVENTION

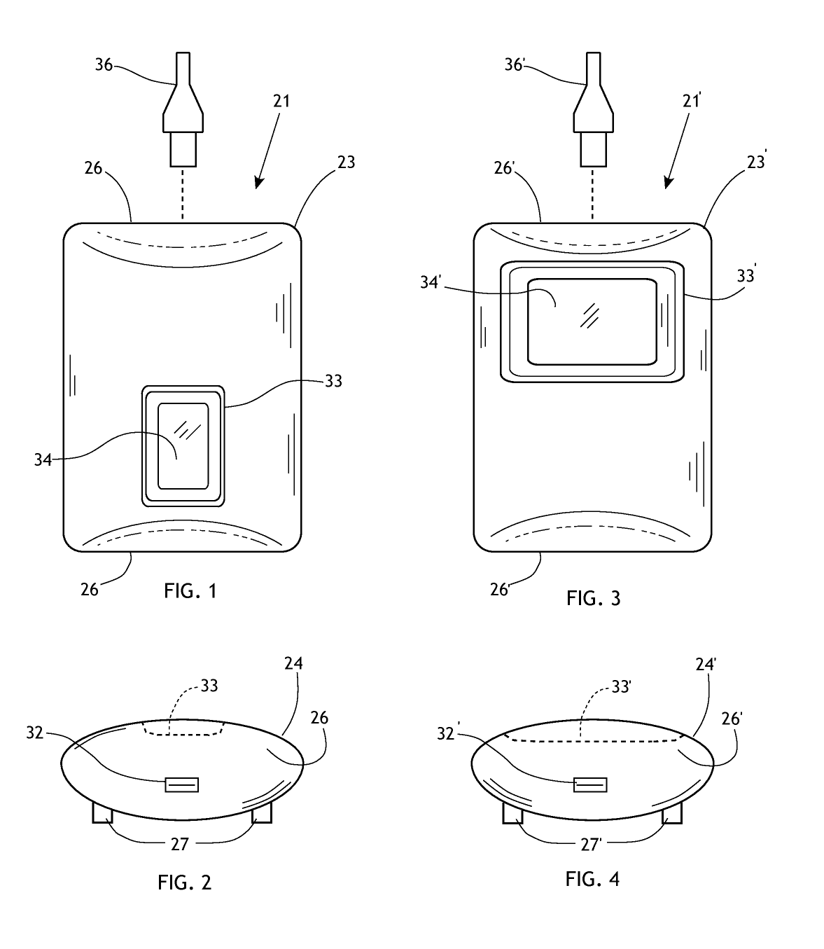

The present invention generally comprises a modular identity authentication device for use with a terminal or workstation or desktop computer setup. With regard to FIGS. 1 and 2, one embodiment of the device 21 includes an exterior housing 23 with a closed curved continuous surface 24 having a generally rectangular plan layout. The pod-like housing 23 has a cross-sectional configuration and end surfaces 26 that are generally ovoid, as shown in FIG. 2. A plurality of foot lugs 27 is formed in the surface 24 to establish a firm and stable resting base for the device, and defines the bottom of the housing 23.

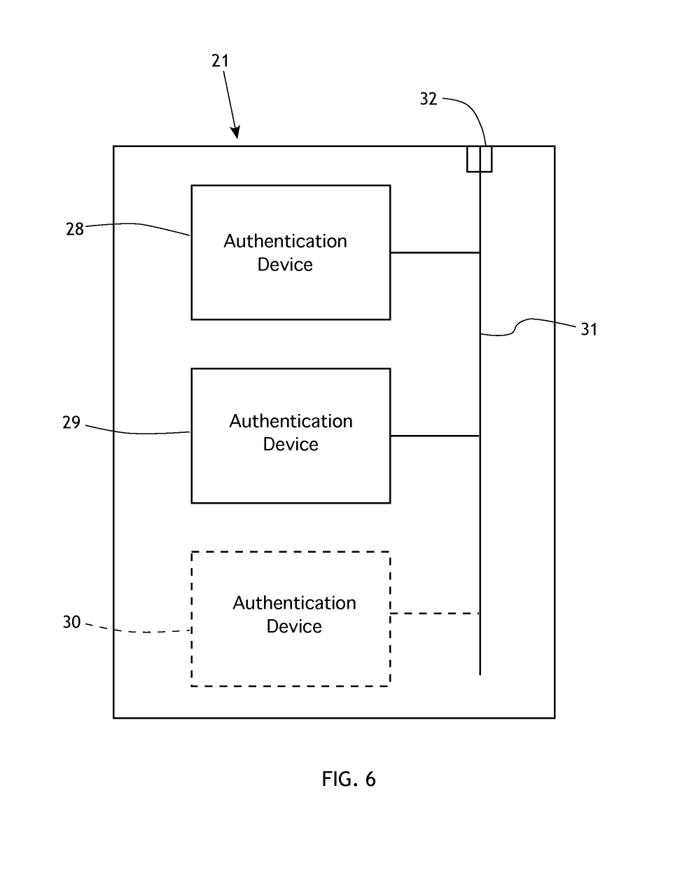

As shown in FIG. 6, within the housing 23 there are two different authentication devices 28 and 29, which are connected to a data/power bus 31 such as a USB network connected to an external plug receptacle 32. The authentication devices are powered by the bus 31, and meet the dual identification modalities requirement currently in force. They may comprise one biometric authentication device and one RFID/NFC device, both known in the art. For example, the two devices may comprise a biometric device and a PCProx RFID device. The external appearance of the device 21 does not reveal the presence of the second authentication device within the housing, nor how it operates, nor which forms of RFID cards or badges are accepted by the device.

Alternatively, a third authentication device 30 may be provided in the module, likewise joined to the data/power connection 31. The device 30 may comprise a BYOD identification module that elicits an identification signal exchange with an electronic device that generally accompanies the particular individual who is seeking to be authenticated by devices 28 and 29 in the same generally time frame. This ID exchange may take place on a Bluetooth™ network built into the device 30, or other similar communication standards.

Returning to FIG. 1, the housing 23 is provided with an inset or recess 33 in the top surface thereof to display a window 34 of a biometric authentication device. The window comprises the input port of a standard fingerprint reader module known in the prior art, or an iris scanner, either of which may comprise one of the authentication devices 28 or 29. A USB cable 36 connects to the bus 31 through the module's plug receptacle 32 to power the devices 28-29 (and 30) and to provide digital communications therewith. The cable 36 is connected in turn to a USB port of a computer terminal which may include a display screen and/or touch screen, and/or mouse or keyboard or other manual input device. The computer system software identifies the device 21 and associates it with the particular terminal and with the individuals who are authorized to use that particular terminal

With regard to FIGS. 3 and 4, an alternative embodiment of the invention comprises a pod-like device 21′. Components similar to those of the previous embodiment are accorded the same reference numerals with a prime (′) designation. A notable difference is that the inset recess 33′ supports the interface window 34′ of an RFID or near field communications device that is disposed to read a coded badge or personal ID card that is moved into proximity to the window 34′. The second authentication device within the housing 23 may not be discerned by the outward appearance of the device 21. It may comprise a second card or badge reader, or the BYOD sensor described above.

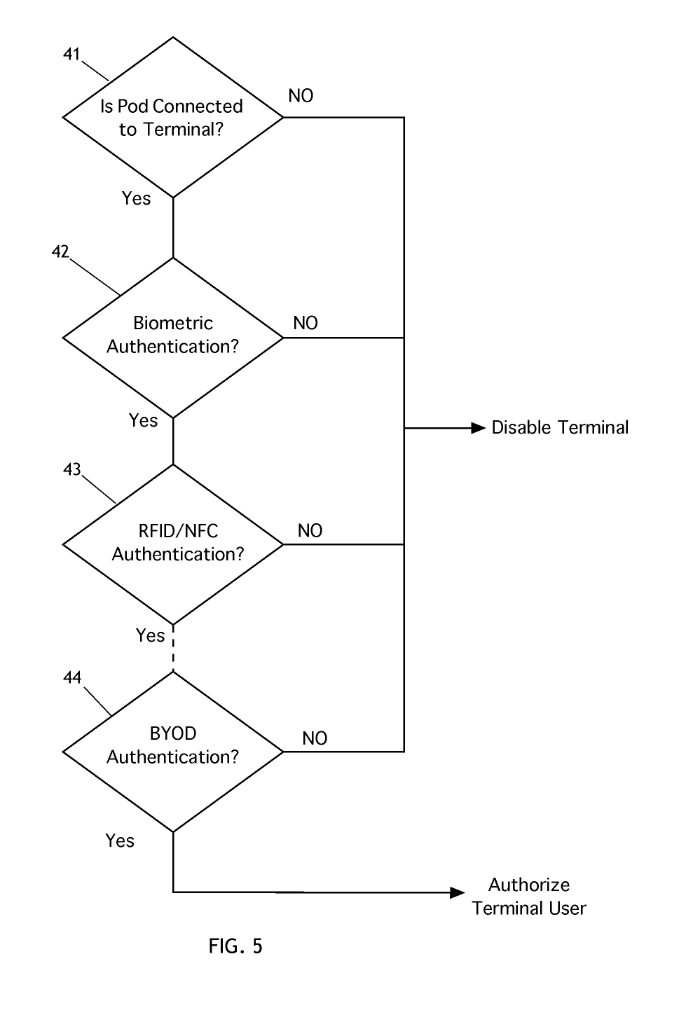

With reference to FIG. 5, the system software that operates with the device 21 or 21′ first takes step 41 to survey the devices connected at a terminal to determine if the device 21 or 21′ is connected to the terminal If the device (pod) is connected properly, the authentication routing proceeds. Otherwise, the terminal is disabled to protect the security of the computer system. The routine then proceeds at step 42 to undertake the biometric authentication step, which may comprise having the user to carry out a fingerprint scan. If the scan successfully identifies an individual associated with the terminal, then the ID routine proceeds. Otherwise the terminal is disabled. The software routine then carries out step 43, an RFID/NFC scan of any active ID cards or badges that are moved into proximate position to the device 21 and are capable of being read by the devices 28 or 29. If this identity authentication is successful, the terminal user is authorized and access to the terminal is opened.

Alternatively, a further step 44 may be carried out to scan the area proximate to the device 21 to detect any identifiable electronic devices that a person authorized to use the terminal may be carrying, such as a mobile phone, tablet, smart watch, or the like. The system software is provided with a list of devices that the user may own or possess, and verification of one of these devices further serves to authenticate a valid user.

Note that if the biometric sensor such as a fingerprint reader is not used, the two-factor authentication routine relies on two different forms of RFID or NFC or BYOD identification (steps 41, 43, and 44) to validate the user's identity. Moreover, depending on the model chosen, more than one type of ID card may be supported by each authentication device. For example, card scanner devices may include dual band readers that operate in both the 125 Khz and 13.5 Mhz ranges. These readers work with application software via API's that are available from the manufacturers. In this invention the two authentication devices work independently of each other, and employ different sensor modalities. Although the preferred embodiment describes the use of a biometric sensor such as a fingerprint reader combined with an RFID/NFC badge/card reader, it may be necessary or desirable to employ two differing badge/card readers in some circumstances. For example, in some medical settings where the personnel are gloved for long periods, the use of a fingerprint reader is sub-optimal, and two badge/card readers within the device 21 or 21′ is a more suitable combination of authentication devices.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiments described are selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A modular authentication apparatus for a terminal of a computer system, including:
a pair of identity authentication devices, each operating independently and connected to an internal bus that provides power and data communications;
said pair of identity authentication devices being secured within a single closed housing;
plug means for connecting said internal bus of said modular authentication apparatus to said computer system to control access to said computer system at said terminal;
said computer system detecting the connected presence of said modular authentication apparatus and disabling said terminal whenever said modular authentication apparatus is disconnected from said terminal.

2. The modular authentication apparatus of claim 1, wherein one of said identity authentication devices includes a biometric identification device for identifying a biometric trait of an individual authorized to use said terminal

3. The modular authentication apparatus of claim 2, wherein the other of said identity authentication devices comprises an RFID/NFC identification device for identifying an RF-responsive card or badge of said individual authorized to use said terminal.

4. The modular authentication apparatus of claim 3, wherein said plug means includes an external plug connector coupled to said internal bus.

5. The modular authentication apparatus of claim 1, wherein said closed housing includes a window formed in an upper surface thereof.

6. The modular authentication apparatus of claim 5, wherein one of said identity authentication devices includes a biometric identification device for identifying a biometric trait of an individual authorized to use said terminal, and said window is an input port for said biometric identification device.

7. The modular authentication apparatus of claim 6, wherein said biometric identification device comprises a fingerprint reader.

8. The modular authentication apparatus of claim 6, wherein said biometric identification device comprises an iris scanner.

9. The modular authentication apparatus of claim 5, wherein one of said identity authentication devices includes an RFID/NFC identification device for identifying an RF-responsive card or badge of an individual authorized to use said terminal, and said window is an input port for said RFID/NFC identification device.

10. The modular authentication apparatus of claim 3, further including a third identity authentication device comprising a BYOD detector for identifying an electronic device accompanying said individual authorized to use said terminal.

11. The modular authentication apparatus of claim 10, wherein said third authentication device is a Bluetooth™ device.

12. The modular authentication apparatus of claim 3, wherein said computer system enables said terminal only when said pair of identity authentication devices transmit positive validation signals to said computer system.

13. The modular authentication apparatus of claim 10, wherein said computer system enables said terminal only when said pair and said third identity authentication devices all transmit positive validation signals to said computer system.
